(19) United States
(12) Patent Application Publication
(10) Pub. No.: US 2011/0241341 A1
(43) Pub. Date: Oct. 6, 2011

(54) EXHAUST PIPE FOR A MOTOR VEHICLE AND EXHAUST SYSTEM

(75) Inventors: Andreas BAUER, Maintal (DE); Brian Thomas IGNACZAK, Rochester, MI (US)

(73) Assignee: NORMA GERMANY GMBH, Maintal (DE)

(21) Appl. No.: 13/074,696

(22) Filed: Mar. 29, 2011

(30) Foreign Application Priority Data
Mar. 30, 2010 (DE) 102010013412.0

(51) Int. Cl. F16L 21/02; B60K 13/04; F16J 15/08

(52) U.S. Cl. 285/374; 277/626

(57) ABSTRACT

Exhaust pipe for a motor vehicle, exhaust system of a motor vehicle, and radial seal for an exhaust pipe. The exhaust pipe includes at least one first end section having an insert region and at least one second end section having a receiving region. The at least one first and second end sections are connectable to one another in a gas-tight manner by inserting the insert region into the receiving end. A metallic radial seal is arranged between the insert region and the receiving region.

### CROSS-REFERENCE TO RELATED APPLICATIONS

The present application claims priority under 35 U.S.C. §119 of German Patent Application No. 10 2010 013 412.0, filed on Mar. 30, 2010, the disclosure of which is expressly incorporated by reference herein in its entirety.

### BACKGROUND OF THE INVENTION

1. Field of the Invention

The invention relates to an exhaust pipe for a motor vehicle with at least one first end section and at least one second end section that are connected to one another in a gas-tight manner. Furthermore, the invention relates to an exhaust system of a motor vehicle with an exhaust pipe of this type.

2. Discussion of Background Information

The generally very hot exhaust gases of an internal combustion engine are dissipated through exhaust pipes of a motor vehicle. The exhaust gases generally contain toxic constituents, so that the exhaust gases must be prevented from leaking out of the exhaust pipe. Since it is not possible to produce an exhaust pipe from a single pipe piece, end sections of individual pipe sections have to be connected to one another in a gas-tight manner. The exhaust pipes are thereby generally made of a metal, such as, e.g., a rustproof steel. It is thereby possible to weld different end sections of individual pipes to one another and to thus obtain a gas-tight connection.

It is also known to screw end sections to one another. In this case, additional screw clamps sometimes have to be used. In the case of threaded connections, however, there is a danger that they can be loosened by vibrations, such as occur, e.g., during the operation of a motor vehicle. Consequently, a gas-tight connection is then not always ensured.

The production of the connection of the end sections requires a relatively large expenditure. For example, the welding of the end sections can be carried out only by corresponding trained staff. A threaded assembly of the end sections also requires a relatively large amount of time. The necessary tightness is not always ensured thereby.

### SUMMARY OF THE INVENTION

Embodiments of the invention reduce the expenditure for producing a gas-tight connection of the two end sections.

According to the embodiments, an exhaust pipe of the type mentioned at the outset includes a first end section having an insert region that is inserted into a receiving region of a second end section. A metallic radial seal is arranged between the insert region and the receiving region.

Accordingly, a connection of the two end sections is carried out only by simple insertion. Thus, the first and second end sections form a push fit coupling. The necessary tightness is produced not by the introduction of forces, as in the case of a threaded connection, or by a closure by adhesive force, as in the case of welding, but with the aid of the metallic radial seal. The radial seal radially seals the first end section with respect to the second end section. An adequate temperature resistance is guaranteed by the use of a metallic material, so that no damage to the seal is caused even by hot exhaust gases. Further, a metallic material has sufficient elasticity to compensate for tolerances between the insert region and the receiving region and for temperature fluctuations. The production expenditure for the exhaust pipe is therefore greatly reduced by the simple plug connection with a metallic radial seal between the insert region and the receiving region. Moreover, a cost-effective production is possible at the same time.

Preferably, the first and the second end section are engaged with one another. An accidental release of the end sections from one another is prevented by an engagement of the end sections. The tightness of the exhaust pipe is ensured even when vibrations occur. The engagement needs only to prevent a release of the end sections from one another, and does not need to ensure a seal. Accordingly, the engagement can be carried out with relatively simple elements.

Preferably, the radial seal has a full perimeter projection projecting in a first radial direction on a first axial end and a first sealing lip on a second axial end, which first sealing lip is tilted in the opposite direction to the first radial direction. This embodiment increases the elasticity of the radial seal. A relatively large amount of material is available for a deformation of the radial seal due to the elements sealing lip and projection, projecting in opposite radial direction at different ends, one of which bears against the insert region and one bears against the receiving region. A deformation is possible, as it were, diagonally across the cross section of the radial seal. The necessary elasticity can thereby also be obtained by a metallic seal in order to compensate for greater tolerances. For example, a tolerance compensation of plus/minus 3/10 mm is possible, wherein a tightness is ensured over the entire region.

Preferably, the radial seal has a second sealing lip tilted in the first radial direction on the second end. The second sealing lip is thus arranged on the same end as the first sealing lip, but tilted in the opposite radial direction. A second sealing surface is obtained thereby. The sealing lips can be embodied with relatively thin walls so that a high elasticity is obtained.

It is particularly preferred thereby that an annular groove is embodied between the sealing lips. The elasticity of the radial seal is increased by the provision of an annular groove. In particular a movement of the sealing lips towards one another is facilitated. The sealing lips can then have a radial distance from one another in the unloaded state that is greater than a distance between the insert region and the receiving region in the radial direction. During the insertion of the insert region into the receiving region, an elastic deformation of the sealing lips then occurs, which is easily possible due to the provision of the annular groove. A relatively large deformation is thereby possible, so that tolerances can be compensated for well without leading to problems regarding the tightness.

Preferably, a jacket surface of the radial seal is tilted to a rotational axis and in particular continuously merges into the first sealing lip. A thickness of the radial seal thus steadily increases from a first to the second axial end. The radial seal on the first axial end is thereby spaced apart with its jacket surface from the corresponding end section, so that a deformation of the radial seal is possible by the full perimeter projection located at the same height. The counter-bearing for this deformation is then formed by the first sealing lip. With a continuous transition of the jacket surface into the sealing lip, the occurrence of peak stresses is avoided and a long service life of the radial seal is thus achieved.

Preferably, the first sealing lip extends axially further than the second sealing lip. It is thereby possible to provide a relatively large sealing region in the region of the first sealing lip. The full perimeter projection is also located on the side of the second sealing lip, so that in all a sufficient tightness is guaranteed there.

Preferably, the projection extends further in the first radial direction than the second sealing lip in the unloaded state of the radial seal. It is thereby ensured that the main deformation of the radial seal is caused by the full perimeter projection and not by the sealing lip. The second sealing lip is unloaded thereby.

The radial seal is preferably held in one of the end sections in a radially preloaded manner. The radial seal is thereby held with the aid of the projection, which extends further in the radial direction than the second sealing lip. Through the radial preloading, the radial seal can be preassembled in one of the end sections. The assembly is thereby simplified.

In a preferred embodiment, the receiving region has a region with enlarged diameter towards a free end, wherein the radial seal is arranged in the region. This region with enlarged diameter on the one hand facilitates the insertion of the insert region and on the other hand renders possible the protected arrangement of the radial seal. While the actual guidance of the insert region in the receiving region takes place outside the region with enlarged diameter, the radial seal does not need to absorb any guide forces. Accordingly, the stress on the radial seal is kept low, so that a high service life can be expected. The radial seal is thereby arranged such that the first axial end is facing towards the free end of the receiving region. The inner jacket surface of the radial seal is then tilted such that it likewise has an increasing internal diameter in the direction towards the free end. An insertion of the insert region along the radial seal is thereby possible in a relatively simple manner, wherein an elastic deformation of the sealing lips takes place. With a withdrawal of the insert region, however, the sealing lip is held on the insert region by friction and thus increases the sealing effect. At the same time, exhaust gas possibly flowing through between the insert region and the receiving region can reach the annular groove of the radial seal. This exhaust gas then pushes the two sealing lips radially apart, and thus guarantees a secure bearing of the sealing lips. The radial seal is thus, as it were, self-sealing.

Preferably, the radial seal is arranged between a retaining ring and reduction of diameter of the receiving region, in particular, a step-shaped reduction. An axial displacement of the radial seal is then reliably prevented. The retaining ring can be, e.g., pressed in. The assembly of the retaining ring is then relatively simple.

Preferably, the insert region has a locking projection, with a locking side and a run-up side that is, in particular, tilted to the rotational axis. A locking element bears against the locking side. The locking element can slide over the run-up side during the insertion of the insert region into the receiving region and thereby be opened. Thereafter, the locking element can snap in behind the locking projection as soon as the insert region has been completely inserted into the receiving region. The locking side thereby extends in the radial direction so that an axial withdrawal of the insert region out of the receiving region is prevented by form closure between the locking element and the locking side.

In a preferred embodiment, the locking element is embodied or formed as a spring brace, which is guided in a slot in the receiving region. The spring brace is embodied or formed in a U-shaped manner if necessary, and branches of the spring braces respectively have a section curved outwards, the internal radius of which corresponds to an external radius of the insert region. Through an embodiment of this type of the locking element, the locking element can be prepositioned in the slot or slots of the receiving region, so that an insertion of the insert region is possible without additional activation of the spring brace. The spring brace rather snaps in automatically behind the locking projection, as soon as the insert region has been fully received in the receiving region. Through the curved embodiment of the branches of the spring brace, the spring brace bears against the locking projection over a relatively large region. Relatively large forces can be transferred thereby.

Embodiments are directed to an exhaust system. An exhaust system of this type has a plurality of pipe elements and additional elements. The end sections of pipe elements have to be respectively connected to one another. A gas-tight connection is thereby necessary due to the often toxic exhaust gases. Through the connection of the end sections to one another by a push fit coupling, a metallic radial seal is arranged between the insert region and the receiving region, the production of a gas-tight connection is relatively simple and easily possible. The pipes can thereby be embodied or formed in one piece with the end sections and can be made of, e.g., metal. The receiving region and the insert region are then also made of metal and form a metal coupling or a plug-in coupling.

Embodiments of the invention are directed to an exhaust pipe for a motor vehicle. The exhaust pipe includes at least one first end section having an insert region and at least one second end section having a receiving region. The at least one first and second end sections are connectable to one another in a gas-tight manner by inserting the insert region into the receiving end. A metallic radial seal is arranged between the insert region and the receiving region.

According to embodiments, the first end section and the second end section can be engaged with one another.

In accordance with embodiments of the invention, the radial seal can include a first axial end with a full perimeter projection extending in a first radial direction and a second axial end with a first sealing lip that is tilted in a direction opposite to the first radial direction. The second axial end may have a second sealing lip tilted in the first radial direction. The exhaust pipe can also include an annular groove formed between the sealing lips. The first sealing lip can extend axially further than the second sealing lip. Moreover, when the radial seal is in an unloaded state, the projection extends further in the radial direction than the second sealing lip.

According to other embodiments, the radial seal may further include a jacket surface tilted to a longitudinal axis. The jacket surface can continuously merge into the first sealing lip.

In accordance with still other embodiments of the instant invention, the radial seal can be held in one of the at least one first and second end sections in a radially preloaded manner.

Further, the receiving region can include an enlarged region with enlarged diameter towards a free end. The radial seal may be arranged in the enlarged region.

The exhaust pipe can further include a retaining ring. The receiving region may include a reduced diameter region and the radial seal can be arranged between a retaining ring and the reduced diameter region. The reduced diameter region can include a step-shaped reduction of diameter.

According to other embodiments, the exhaust pipe can include a locking element. The insert region may have a locking projection with a locking side and a run-up side. A locking element can bears against the locking side. Further, the run-up side is tilted to a longitudinal axis of the insert region. The locking element can include a spring brace that is guided in a slot in the receiving region. The spring brace may include a U-shaped member with branches having outwardly curved sections that have an internal radius corresponding to an external radius of the insert region.

Embodiments of the invention are directed to an exhaust system of a motor vehicle that includes an exhaust pipe of the type described above.

Embodiments of the invention are directed to a radial seal for an exhaust pipe. The radial seal includes first and second axial ends having centers aligned along a longitudinal axis, an inner annular end forming a surface oriented at an angle to the longitudinal axis, an outer annular end, an annular groove formed in the second axial end, and a radial projection extending from the outer annular end at the first axial end.

In accordance with still yet other embodiments of present invention, the annular groove can be formed between first and second lips, in which the first lip extends beyond the second lip in the axial direction and the inner annular end continuously merges into the first lip.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a cross section through a connection region of an exhaust pipe;

FIG. 2 illustrates a plan view of FIG. 1;

FIG. 3 illustrates a section from FIG. 1; and

FIG. 4 illustrates a single view of a radial seal in an unstressed state.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

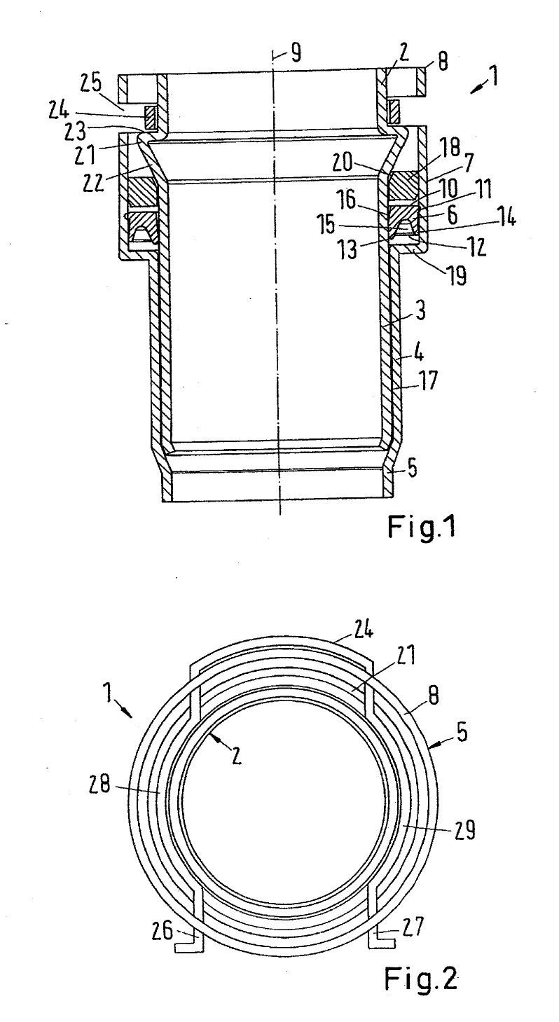

An exhaust pipe 1 for a motor vehicle (not shown) is shown diagrammatically in cross section in FIG. 1. A first end section 2 is thereby inserted with an insert region 3 into a receiving region 4 of a second end section 5. End sections 2, 5 are parts of pipes of exhaust pipe 1. Exhaust pipe 1 is made of, e.g., a metallic material.

To produce a gas-tight connection between first end section 2 and second end section 5, a metallic radial seal 6 is arranged between insert region 3 and receiving region 4. Metallic radial seal 6 is arranged in a region 7 of receiving region 4 having an enlarged diameter. Region 7 is embodied or formed on a free end 8 of second end section 5.

Radial seal 6 is embodied or formed in an annular manner and is rotationally symmetrical to a central or longitudinal axis 9. On a first axial end 10, radial seal 6 has a full perimeter projection 11, which is directed radially outwards. On a second axial end 12, radial seal 6 has a first sealing lip 13 tilted radially inwards and a second sealing lip 14 directed radially outwards. An annular groove 15 is embodied or formed between first sealing lip 13 and second sealing lip 14. Annular groove 15 is delimited by sealing lips 13, 14.

A jacket surface 16 of radial seal 6, lying radially inside, runs at an angle to axis 9. A smallest interior diameter is embodied or formed in the region of second axial end 12 and a largest interior diameter is embodied in the region of first axial end 10. further, the interior diameter can change constantly.

Radial seal 6 bears with projection 11 and second sealing lip 14 radially against receiving region 4 and with first sealing lip 13 bearing against insert region 3. Since a radial spacing between first sealing lip 13 and second sealing lip 14 is greater than a radial spacing between insert region 3 and the receiving region 4, an elastic deformation of radial seal 6 takes place. Radial seal 6 is thereby deformed radially inwards in region 6 in the region of projection 11 so that the tilt of jacket surface 16 is reduced. First sealing lip 13 is thereby pressed against insert region 3. At the same time, second sealing lip 14 bears against receiving region 4. In this manner, a gas-tight seal is thereby obtained.

When exhaust gas flows through a gap 17, possibly present due to component tolerances, between insert region 3 and receiving region 4, it reaches annular groove 15 of radial seal 6. The exhaust gas then presses first sealing lip 13 and second sealing lip 14 radially apart, thus, intensifying the respective bearing on insert region 3 or on receiving region 4. With increasing pressure of the exhaust gas, the sealing effect is thus increased, which ensure a very secure sealing.

Radial seal 6 can be secured by being arranged between a retaining ring 18 and a step-shaped reduction of diameter 19 of receiving region 4. An axial displacement of radial seal 6 is therefore possible only to a slight extent. Retaining ring 18 can be pressed into region 7 from free end 8. An edge 20 lying on the radial inside of retaining ring 18 faces towards free end 8 and is beveled in order to render possible a simple insertion of insert region 3 and in order to prevent a jamming with insert region 3.

A locking projection 21 with a run-up side 22 and a locking side 23 is embodied or formed in insert region 3. Run-up side 22 is thereby tilted to axis 9, while the locking side 23 runs in the radial direction. When first end section 2 with its insert region 3 is fully received in receiving region 4 of second end section 5, a locking element 24 snaps in behind locking projection 21 and thus prevents an accidental detachment of first end section 2 from second end section 5. Locking element 24 are thereby arranged in a slot 25, which is embodied or formed in receiving region 4. Locking element 24 is elastically deformable thereby.

In FIG. 2, gas pipe 1 from FIG. 1 is shown in plan view. Locking element 24 is embodied or formed as a U-shaped spring brace with a first branch 26 and a second branch 27. Each branch 26, 27 thereby has a respective section 28, 29 curved outwards, with an interior diameter corresponding to an exterior diameter of first end section 2 in insert region 3. A relatively large bearing surface for branches 26, 27 on locking projection 23 is thereby possible.

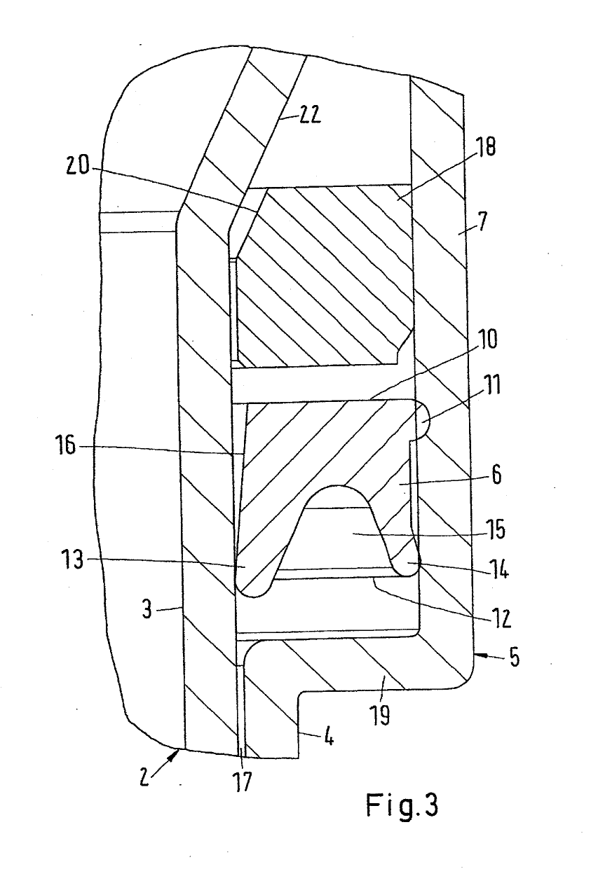

FIG. 3 shows in detail the arrangement of radial seal 6 and retaining ring 18 in region 7 of receiving region 4 of second end section 5. The same parts are thereby provided with the same reference numbers. Projection 11 is depicted to show that it extends into a side wall in region 7 and to clarify that radial seal 6 has an oversize and, therefore, is held prestressed in receiving region 4 or in region 7. Radial seal 6 in fact is deformed such that projection 11 is moved radially inwards, so that jacket surface 16 is moved in the direction towards insert region 3, which reduces its tilt. First sealing lip 13 is thereby pressed against insert region 3. At the same time, second sealing lip 14 is pressed against receiving region 4. A good tolerance compensation can thereby take place, such that a high degree of tightness is ensured at the same time. A relatively large surface is thereby available for a deformation of radial seal 6. The elasticity of radial seal 6 is increased still further by the embodiment of annular groove 15. Even if the radial seal 6 does not have such a high elasticity as a rubber seal due to its embodiment with a metallic material, large tolerances can thus be compensated for.

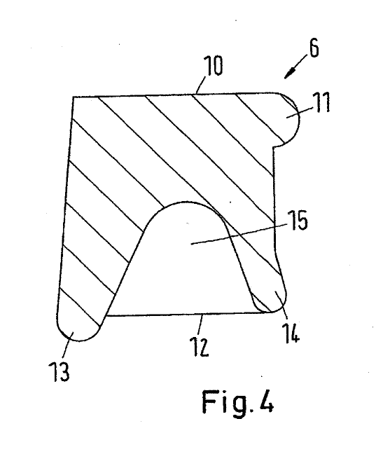

FIG. 4 shows a cross section of radial seal 6. The same elements are thereby again provided with the same reference numbers.

In contrast to the previously described customary exhaust pipes, embodiments of the invention are directed to a push fit coupling to connect the two end sections. The necessary tightness is thereby obtained through a metallic radial seal, which is sufficiently temperature-resistant, since it is made of a metallic material. A high elasticity is therefore ensured by the special shaping of the radial seal.

A relatively large-area deformation of radial seal 6 takes place due to the interaction of radial projection 11 with radial sealing lips 13, 14. Relatively large sealing surfaces are thereby available through the provision of radial seals 6. At the same time, an exhaust gas possibly pressing against the radial seal 6 can be used to reinforce the seal. In all, therefore, a gas-tight connection is obtained although the production manages without the complex connection methods previously necessary.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An exhaust pipe for a motor vehicle comprising:
at least one first end section having an insert region;
at least one second end section having a receiving region, wherein the at least one first and second end sections are connectable to one another in a gas-tight manner by inserting the insert region into the receiving end; and
a metallic radial seal being arranged between the insert region and the receiving region.

2. The exhaust pipe in accordance with claim 1, wherein the first end section and the second end section are engaged with one another.

3. The exhaust pipe in accordance with claim 1, wherein the radial seal comprising a first axial end with a full perimeter projection extending in a first radial direction and a second axial end with a first sealing lip that is tilted in a direction opposite to the first radial direction.

4. The exhaust pipe in accordance with claim 3, wherein the second axial end has a second sealing lip tilted in the first radial direction.

5. The exhaust pipe in accordance with claim 4, further comprising an annular groove formed between the sealing lips.

6. The exhaust pipe in accordance with claim 1, wherein the radial seal further comprises a jacket surface tilted to a longitudinal axis.

7. The exhaust pipe in accordance with claim 6, wherein the jacket surface continuously merges into the first sealing lip.

8. The exhaust pipe in accordance with claim 4, wherein the first sealing lip extends axially further than the second sealing lip.

9. The exhaust pipe in accordance with claim 3, wherein, when the radial seal is in an unloaded state, the projection extends further in the radial direction than the second sealing lip.

10. The exhaust pipe in accordance with claim 1, wherein the radial seal is held in one of the at least one first and second end sections in a radially preloaded manner.

11. The exhaust pipe in accordance with claim 1, wherein the receiving region includes an enlarged region with enlarged diameter towards a free end, wherein the radial seal is arranged in the enlarged region.

12. The exhaust pipe in accordance with claim 1, further comprising a retaining ring, wherein the receiving region includes a reduced diameter region and the radial seal is arranged between a retaining ring and the reduced diameter region.

13. The exhaust pipe in accordance with claim 12, wherein the reduced diameter region includes a step-shaped reduction of diameter.

14. The exhaust pipe in accordance with claim 1, further comprising a locking element, wherein the insert region has a locking projection with a locking side and a run-up side, wherein a locking element bears against the locking side.

15. The exhaust pipe in accordance with claim 14, wherein the run-up side is tilted to a longitudinal axis of the insert region.

16. The exhaust pipe in accordance with claim 14, wherein the locking element comprises a spring brace that is guided in a slot in the receiving region.

17. The exhaust pipe in accordance with claim 16, wherein the spring brace comprises a U-shaped member with branches having outwardly curved sections that have an internal radius corresponding to an external radius of the insert region.

18. An exhaust system of a motor vehicle with an exhaust pipe according to claim 1.

19. A radial seal for an exhaust pipe, comprising:
first and second axial ends having centers aligned along a longitudinal axis;
an inner annular end forming a surface oriented at an angle to the longitudinal axis;
an outer annular end;
an annular groove formed in the second axial end; and
a radial projection extending from the outer annular end at the first axial end.

20. The radial seal in accordance with claim 19, wherein the annular groove is formed between first and second lips, in which the first lip extends beyond the second lip in the axial direction and the inner annular end continuously merges into the first lip.
